(19) United States
(12) Patent Application Publication
(10) Pub. No.: US 2025/0284932 A1
(43) Pub. Date: Sep. 11, 2025

(54) Artificial Intelligence Deliberative Assembly (AIDA)

(71) Applicant: Aqfer, Inc., Windermere, FL (US)

(72) Inventors: Ross Williams, Orlando, FL (US); Daniel Jaye, Wintergarden, FL (US)

(21) Appl. No.: 19/075,941

(22) Filed: Mar. 11, 2025

Related U.S. Application Data
(60) Provisional application No. 63/563,824, filed on Mar. 11, 2024.

(51) Int. Cl. G06N 3/045; G06N 3/0475

(52) U.S. Cl. CPC G06N 3/045; G06N 3/0475

(57) ABSTRACT

A generative AI process that preferably employs various LLMs to collaborate on a prompt in order to return a desirable response. This process uses prompt engineering in a chain approach to allow different LLMs to contribute to or modify an existing answer until a consensus is reached. By integrating multiple models (or instances of a single model) within the generation pipeline, the process ensures the accuracy and relevance of output, significantly enhancing the reliability of AI-generated content.

### BACKGROUND

This disclosure relates generally to the field of Artificial Intelligence (AI), and more specifically to Generative AI, Large Language Models (LLMs), and the applications that utilize them.

Existing Large Language Models (LLMs), and Gen AI Applications by extension, often produce “hallucinations” or inaccurately generated content that does not align with factual information or the intended output of the prompt. Additionally, the output of any particular LLM may be insufficient in responding to certain subjects compared to other available LLMs, making it difficult to choose from available models.

Current solutions for reducing hallucination include various training techniques, data filtering methods, and post-generation correction algorithms. Prompt engineering methods are used to modify behaviors and improve performance of LLMs in certain contexts, which can sometimes involve making multiple invocations of a single LLM. Multi-modal applications make use of different models that work across different mediums, for example giving an output from both a LLM as well as a Generative AI image generation model to produce a story alongside a picture.

One chain-like method known as “Smart LLM” is in the sample notebooks for the Langchain library, which uses 3 different stages (Ideation, Critique, and Resolve) to attempt to answer a question accurately, and each stage can have a different model selected if desired. Smart LLM is a finite chain, with each model playing a certain role, and it does not rely on consensus of all models.

### SUMMARY

This disclosure introduces a Generative AI process that utilizes prompt engineering, preferably in a circular manner, sending the output from one LLM to another, in order to facilitate multiple LLMs “collaborating” on a best response to a prompt and reaching a consensus. The process, which is sometimes referred to herein as Artificial Intelligence Deliberative Assembly (AIDA), returns a final output, with less hallucinations, more relevant information, and more accurate responses.

The foregoing has outlined some of the more pertinent features of the disclosed subject matter. These features should be construed to be merely illustrative. Many other beneficial results can be attained by applying the disclosed subject matter in a different manner or by modifying the subject matter, as will be described below.

### BRIEF DESCRIPTION OF DRAWINGS

For a more complete understanding of the subject matter herein and the advantages thereof, reference is now made to the following descriptions taken in conjunction with the accompanying drawings, in which:

FIG. 1 depicts a first embodiment of a system architecture that implements the AI deliberative assembly technique of this disclosure;

FIG. 2 depicts a second embodiment of a system architecture that implements the technique of this disclosure;

FIG. 3 depicts a representative prompt template for use in the assembly technique of this disclosure;

FIG. 4 depicts a representative JavaScript Object Notation (JSON) object that is expected to be returned by a model in the system;

FIG. 5 depicts a representation configuration file for one implementation of the system and that provides a list of desired models represented by its Python dictionary; and

FIG. 6 depicts representative pseudocode of the AIDA algorithm according to the techniques of this disclosure.

### DETAILED DESCRIPTION

By way of background, a “language model” is a probabilistic model of sequences. In the case of natural language, language models typically describe the probability of sentences or documents. Being simply probabilistic models, language models can take on many specific incarnations, e.g., column frequencies in multiple sequence alignments, Hidden Markov Models, and deep neural networks. A language model is a type of “generative model,” which is a model of a data distribution, p(X), joint data distribution, p(X, Y), or conditional data distribution, p(X|Y=y). It is usually framed in contrast to discriminative models that model the probability of the target given an observation, p(Y|X=x).

In a representative embodiment, the basic notion behind AIDA is as follows. A set of two or more models are configured, typically as a chain. A prompt is send to the chain, and once all models in the chain agree on one response, the response is outputted by the chain. Thus, in lieu of having a single model receive a prompt and return a response, the set of models (an “assembly”) deliberate collaboratively to produce the response.

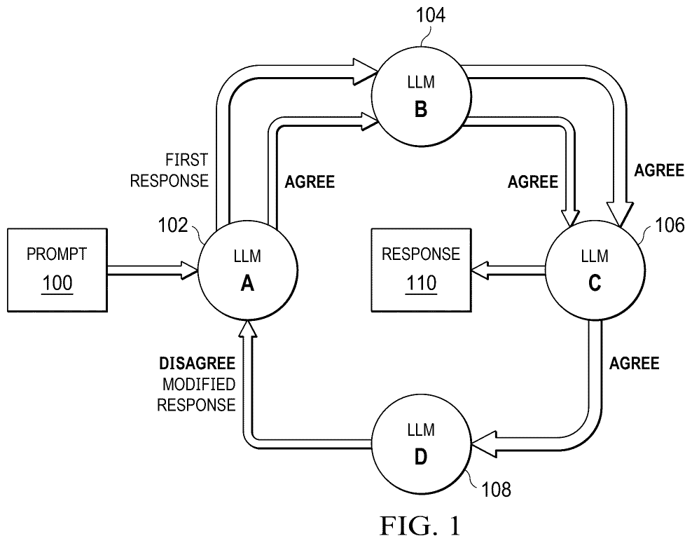

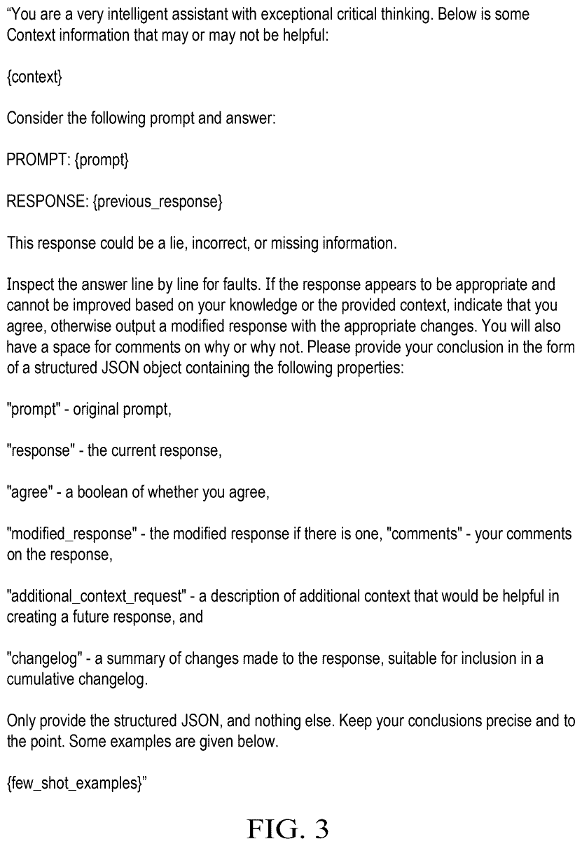

By way of example, and with reference to FIG. 1, a user provides a list of models and a prompt 100, then the AIDA algorithm starts the chain by invoking a first model, LLM A 102, preferably using the “first_response” prompt template, which will result in a response. FIG. 3 depicts a representative first_response prompt template (© Aqfer 2024). This first response is then sent to the next model (here, LLM B 104) in the chain, along with the original prompt, asking if the next model agrees with the response, or if the response can be correct or improved upon. This results in the same or a new response being outputted by the current model in the chain, which is then passed to the next model (here, LLM C 106). This process continues, preferably until all models in the list have been invoked (here, including LLM D 108), and then will call the first model 102 once more to see if it agrees. If any of the models had an improvement or modification to the response, the chain will automatically continue until the model in front of a contesting model also agrees with the current response, in order to reach a consensus. Once a consensus has been reached, the current response is outputted by the algorithm as the final response. In this example shown in FIG. 1, model 106 ends up providing the response 110.

Thus, in the looped example in FIG. 1, the prompt is sent to model A 102, which returns the initial response, and then the deliberation begins. In this example, models 102, 104 and 106 agree with the response, but model D, namely model D, which has an idea for improvement on the response. As such, and in this example, model D is the contesting model. It returns a modified response and sends it back through the chain again for consensus. In this example, model C is the last one to agree before the contesting model, achieving consensus, thereby triggering the final response.

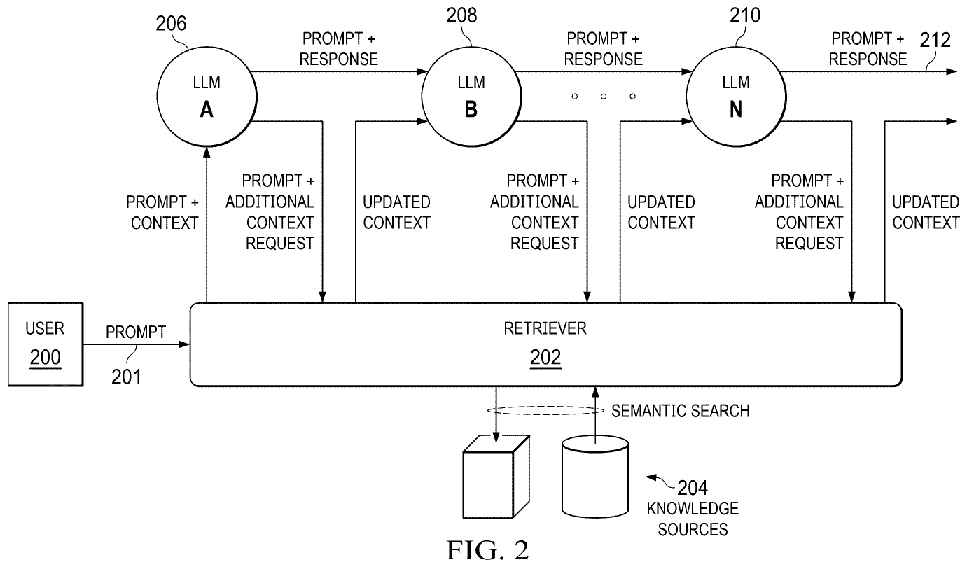

The loop of models architecture shown in FIG. 1 is not intended to be limiting, as the AIDA technique of this disclosure may be implemented in other ways. For example, FIG. 2 depicts a variant embodiment wherein Retrieval Augmented Generation (RAG) techniques are being leveraged. RAG is the process of optimizing the output of an LLM to reference an authoritative knowledge base outside of its training data sources before generating a response. In this example, the RAG system comprises a retriever component 202 and a set of knowledge sources 204 against which the retriever performs semantic searching. As in the FIG. 1, AIDA is executed against a chain of LLMs, namely LLM A 206, LLM B 208 and up to LLM N 210. There may be additional LLMs (or model instances) in the chain. In this embodiment, the process uses RAG to provide context to the models on domain specific knowledge to assist in responding to prompts. As depicted, the AIDA process extends the typical method of generating context from a retriever 202 based on the prompt alone by asking each model in the chain (or at least a given model) how it would like to improve the context, then supplies that information to the retriever along with the original prompt in an attempt to get more relevant contextual information from the retriever. By asking models what other information may be helpful, the approach herein enables the system to send more relevant tokens to the retriever to search the knowledge stores, rather than just a standalone (and potentially vague) prompt from the user.

To ensure that the chain algorithm functions properly, preferably the outputs from the LLMs are in an organized and parse-able format in order for the code to execute the proper logic to continue the chain without disruption or return the final result. To this end, a default template such as shown in FIG. 3 instructs the model to provide structured JSON as an output format, and also by then providing a list of examples to the model in that same format. The nature of the example(s) provided varies as a function of the output that is desired to be generated. The approach of including one or more examples provides for “few shot” prompting, and it helps ensures a parse-able response from each model so that the chain continues to operate appropriately. The example prompt template depicted in FIG. 3 may be customized as necessary to accommodate different models.

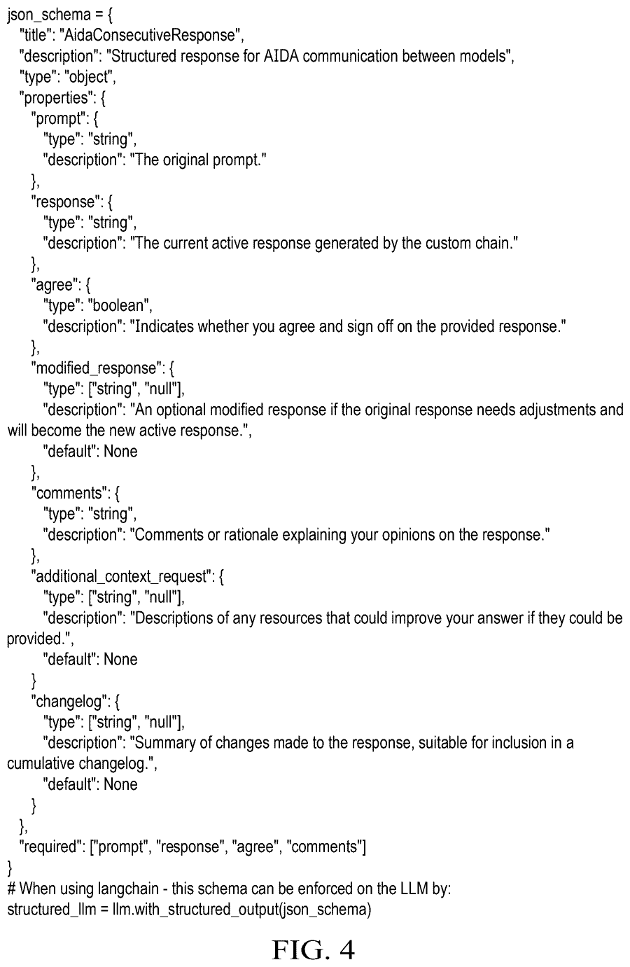

FIG. 4 depicts a representative JSON schema expected to be returned by each model; the JSON output is parsed and then the appropriate information is sent to a next model, and to the RAG retriever if applicable. This representation may be presented to the model in several ways. For example, and in one embodiment, a feature from LangChain using “with_structured_output” for a more universal schema adherence may be used. LangChain is a software framework that helps facilitate the integration of large language models (LLMs) into applications. Another alternative uses prompting that has been trained into the model for that particular purpose, or by describing the desired output format in the custom prompt for the model along with a few examples (such as depicted in FIG. 3).

Chains vary at the user's discretion, e.g., by providing a list of models to be used and in what order in the form of an array, such as: [model1, model2, model3]. The array can be the same model multiple times, various models from different providers, or any combination thereof. Typically, the first model in the array has an important role in that the chain uses this model as the “first response” model (to get the first response), and in the usual case this model is then invoked again at the end of the chain to confirm the consensus. Other options can be utilized, such as a “max_loops” parameter to be used in case consensus is unable to be reached, and also the ability to disable consensus, to just run through the list of models until it reaches the end, in which case the system then returns the then current response at that time.

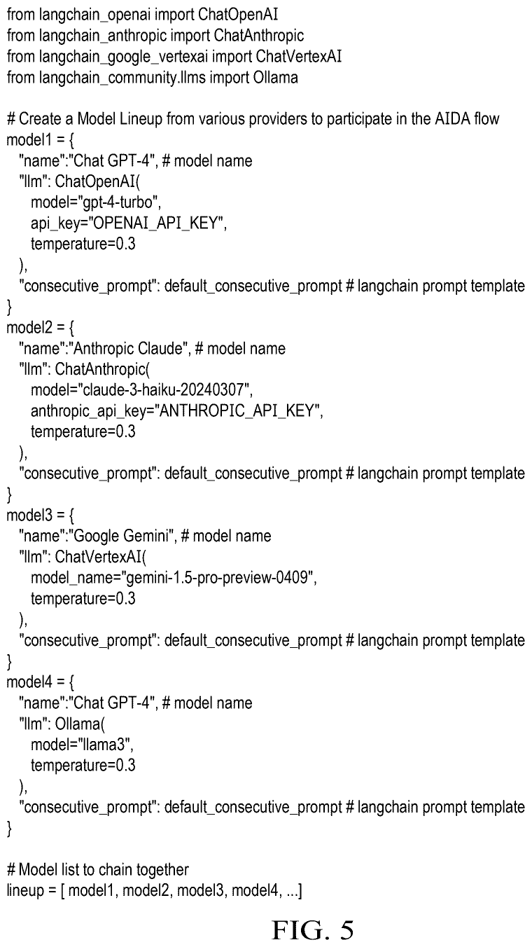

FIG. 5 depicts a representative chain configuration, which includes model from different providers. In this example embodiment, a Jupyter notebook is used to import a LangChain Python library. The library defines each LLM using the respective imports for that provider; in this example, which is not intended to be limited, the following models are used: Open AI GPT 4 Turbo, Anthropic Claude 3 Haiku, Google Gemini-1.5 Pro, and Meta Llama 3. As depicted, the configuration comprises a Python list of desired models to be used, each with each model represented as a Python dictionary. Other configuration formats and tooling may be used to configure and execute the model chain. Once the list is defined, it is passed to the AIDA algorithm with the original prompt (and context retriever if applicable, such as depicted in FIG. 2) to generate a final response after the chain is completed. Although use of different models from different providers can provide useful results, this is not a requirement. A variant approach is to use the same model iteratively.

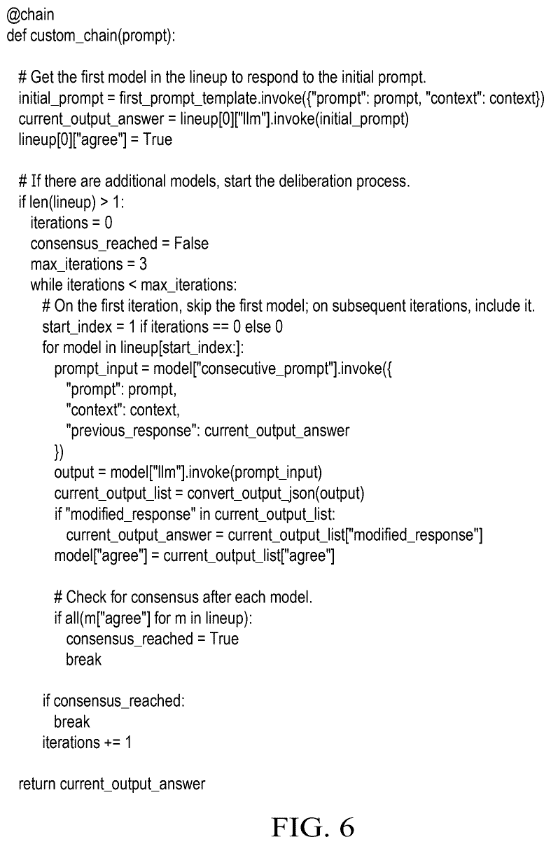

FIG. 6 depicts a simplified version of representative pseudocode for the AIDA algorithm that loops through the lineup of models looking for consensus.

The system may also provide a set of pre-configured chain templates from which a user can choose a desired configuration.

As depicted in the examples, preferably a model also outputs a changelog, representing a summary of changes the model has made to the response. As an output from the consensus, the system may also provide a cumulative changelog describing all of the changes that were generated by the various models during the deliberation.

The techniques herein provide significant advantages. As described, AIDA provides for a generative AI process characterized using a multi-model chain approach designed to reduce hallucinations and improve generated responses. In a typical operating scenario, the user defines the desired models, model parameters, and model order to be used during the process in the form of a list. The list is provided to the AIDA process and segments the generation process into multiple stages, potentially invoking different models (or distinct model instances) to comment on the validity of the response, and add to or modify the response. When a consensus by the models is reached, the response (built from the consensus operation) is then returned to the user.

As a variant embodiment, and instead of just providing a next model in the chain the current active response (and context when RAG is used), the entire history of the conversation, i.e. all notes from all models so far, may be provided to the next model. The system may also implement more verbose modes, wherein the JSON output of each model in the chain is returned to the user along with the final output, so that the user or the system can see what each model responded with, e.g., for debugging or further analysis.

The default prompt template shown in FIG. 3 may be customized depending on the model.

There is no limit on the number of models that may be incorporated into the chain. Conversely, there is no requirement that a chain comprise more than one model (or model instance) in addition to the initial response model.

There is no restriction on the type of use case for the techniques herein, and the same methodology may be used for image generation, wherein the generative AI includes image models.

In a typical use case, the user defines the desired models, model parameters, and model order to be used during the deliberation; one or more preconfigured templates may be used for this purpose as well. The generation process may also be segmented into multiple stages, invoking different models to comment on the validity of the response, and/or to add/modify the response. By integrating multiple models within the generation pipeline, the above-described process provides for better accuracy and relevance of output, significantly enhancing the reliability of the AI-generated content.

### Enabling Technologies

Aspects of this disclosure may be practiced, typically in software, on one or more machines or computing devices. More generally, the techniques described herein are provided using a set of one or more computing-related entities (systems, machines, processes, programs, libraries, functions, or the like) that together facilitate or provide the described functionality described above. In a typical implementation, a representative machine on which the software executes comprises commodity hardware, an operating system, an application runtime environment, and a set of applications or processes and associated data, which provide the functionality of a given system or subsystem. As described, the functionality may be implemented in a standalone machine, or across a distributed set of machines. A computing device connects to the publicly-routable Internet, an intranet, a private network, or any combination thereof, depending on the desired implementation environment.

One implementation may be a machine learning-based computing platform. One or more functions of the computing platform may be implemented in a cloud-based architecture. The platform may comprise co-located hardware and software resources, or resources that are physically, logically, virtually and/or geographically distinct. Communication networks used to communicate to and from the platform services may be packet-based, non-packet based, and secure or non-secure, or some combination thereof.

The techniques herein may be implemented in a system that is network-accessible and executes as a computing platform. Generalizing, one or more functions of the computing platform of this disclosure may be implemented in a cloud-based architecture. As is well-known, cloud computing is a model of service delivery for enabling on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. Available services models that may be leveraged in whole or in part include: Software-as-a-Service (Saas) (the provider's applications running on cloud infrastructure); Platform-as-a-Service (PaaS) (the customer deploys applications that may be created using provider tools onto the cloud infrastructure); Infrastructure-as-a-Service (IaaS) (customer provisions its own processing, storage, networks and other computing resources and can deploy and run operating systems and applications). The platform may comprise co-located hardware and software resources, or resources that are physically, logically, virtually and/or geographically distinct. Communication networks used to communicate to and from the platform services may be packet-based, non-packet based, and secure or non-secure, or some combination thereof. In a more specific embodiment, the platform comprises a set of services, each of which is typically implemented as a set of one or more configurable computing resources (e.g. networks, network bandwidth, servers, processing, memory, storage, applications, virtual machines, and services).

When implemented as-a-service, the AIDA system typically includes one or more Application Programming Interfaces (APIs) to interoperate with the one or more models that participate in the deliberation. In this example, an API call is made to invoke a particular model (or model instance) in the configured chain. In another type of implementation, the system may operate within a particular computing platform, taking advantage of a localhost API (or the like) to access one or more local models or model instances.

Each above-described process or process step/operation preferably is implemented in computer software as a set of program instructions executable in one or more processors, as a special-purpose machine.

Representative machines on which the subject matter herein is provided may be hardware processor-based computers running an operating system and one or more applications to carry out the described functionality. One or more of the processes described above are implemented as computer programs, namely, as a set of computer instructions, for performing the functionality described. Virtual machines may also be utilized.

While the above describes a particular order of operations performed by certain embodiments of the invention, it should be understood that such order is exemplary, as alternative embodiments may perform the operations in a different order, combine certain operations, overlap certain operations, or the like. References in the specification to a given embodiment indicate that the embodiment described may include a particular feature, structure, or characteristic, but every embodiment may not necessarily include the particular feature, structure, or characteristic.

While the disclosed subject matter has been described in the context of a method or process, the subject matter also relates to apparatus for performing the operations herein. This apparatus may be a particular machine that is specially constructed for the required purposes, or it may comprise a computer otherwise selectively activated or reconfigured by a computer program stored in the computer. Such a computer program may be stored in a non-transitory computer readable storage medium, such as, but is not limited to, any type of disk including an optical disk, a CD-ROM, and a magnetic-optical disk, a read-only memory (ROM), a random access memory (RAM), a magnetic or optical card, or any type of media suitable for storing electronic instructions, and each coupled to a computer system bus.

There is no limitation on the type of computing entity that may implement a function or operation as described herein.

While given components of the system have been described separately, one of ordinary skill will appreciate that some of the functions may be combined or shared in given instructions, program sequences, code portions, and the like. Any application or functionality described herein may be implemented as native code, by providing hooks into another application, by facilitating use of the mechanism as a plug-in, by linking to the mechanism, and the like.

The functionality may be co-located or various parts/components may be separately and run as distinct functions, and in one or more locations over a distributed network.

Computing entities herein may be independent from one another, or associated with one another. Multiple computing entities may be associated with a single enterprise entity, but are separate and distinct from one another.

What is claimed here follows below:

1. A method of generative Artificial Intelligence (AI), comprising:
associating a set of machine learning (ML) models together, the set of machine learning models including a first model;
responsive to receipt of a prompt at the first model, generating a first response;
executing a deliberation among the set of ML models with respect to the first response;
determining whether a consensus among the set of ML models has been reached; and
responsive to determining that a consensus among the set of ML models has been reached, returning a final response to the prompt.

2. The method as described in claim 1 wherein the ML models are large language models (LLMs).

3. The method as described in claim 1 wherein the set of ML models comprises at least first and second large language models (LLMs) that differ from one another.

4. The method as described in claim 1 wherein the set of ML models comprises at least first and second instances of a same large language model (LLM).

5. The method as described in claim 1 wherein the set of ML models are associated together in a loop, and wherein the deliberation comprises a given model receiving an input from a previous model in the loop, and wherein the given model generates an output that is then provided to a next model in the loop.

6. The method as described in claim 1 wherein the set of ML models are associated together in a sequence.

7. The method as described in claim 6, further including associating the ML models with a Retrieval Augmented Generation (RAG) retriever.

8. The method as described in claim 7, wherein the deliberation comprises a given model receiving an input from a previous model in the loop, and wherein the given model generates an output that is then provided to a next model in the loop, and wherein the input also includes a context provided by the RAG retriever.

9. The method as described in claim 1, further including specifying the set of ML models in a template.

10. The method as described in claim 9 wherein the template defines an array that specifies the ML models, an order of the ML models, and one or more examples.

11. The method as described in claim 1, further including generating a change log associated with the consensus, the change log identifying a change to at least one given response.

12. A Software-as-a-Service (Saas) computing platform, comprising:
a hardware processor; and
computing memory holding computer program instructions executed by the hardware processor, the computer program instructions configured to provide inferencing by:
associating a set of machine learning (ML) models together, the set of machine learning models including a first model;
responsive to receipt of a prompt directed to the first model, receiving a first response generated by the first model;
initiating execution of a deliberation among the set of ML models with respect to the first response;
determining whether a consensus among the set of ML models has been reached; and
responsive to determining that a consensus among the set of ML models has been reached, returning a final response to the prompt.

13. The SaaS computing platform as described in claim 12, wherein the ML models are large language models (LLMs).

14. The SaaS computing platform as described in claim 12, wherein the set of ML models comprises at least first and second large language models that are one of: a same language model, or different language models.

15. The SaaS computing platform as described in claim 12, further includes one or more Application Programming Interfaces (APIs).

16. The SaaS computing platform as described in claim 15, wherein the set of ML models are associated together in one of: a loop, and a sequence, and wherein the deliberation comprises using the one or more APIs to interface to the set of ML models.

17. The SaaS computing platform as described in claim 15, further including associating at least one of the ML models with a Retrieval Augmented Generation (RAG) retriever.

18. The SaaS computing platform as described in claim 12, wherein the computer program instructions configured to provide inferencing further include program code configured to provide one or more templates configured to receive input that configures the deliberation.
